(19) United States
(12) Patent Application Publication
(10) Pub. No.: US 2026/0210007 A1
(43) Pub. Date: Jul. 23, 2026

(54) SHOCK ABSORBING LAYER AND A METHOD FOR ITS PRODUCTION

(71) Applicant: Sports and Leisure Group NV, Sint-Niklaas (BE)

(72) Inventor: John Penninck, Sint-Niklaas (BE)

(21) Appl. No.: 19/317,778

(22) Filed: Sep. 3, 2025

(30) Foreign Application Priority Data
Sep. 3, 2024 (BE) 2024/5589
Apr. 9, 2025 (CN) 202510440161.0

(51) Int. Cl. D03D 27/02

(52) U.S. Cl. CPC D03D 27/02; D10B 2505/202

(57) ABSTRACT

The present invention relates to a shock-absorbing layer comprising a backing cloth having a top surface, a bottom surface, and a plurality of loops of fibers comprising one or more elastic polymers, having the feature that the loops have a cross-sectional shape comprising at least two free ends and wherein the cross-section between said two ends comprises an elongated segment, wherein the elongated segment extends along a longitudinal axis, wherein the longitudinal axis includes a first tangent vector at a first point and a second tangent vector at a second point, which first and second tangent vectors define a mutual angle between 20° and 160°, preferably between 30° and 150°.

### TECHNICAL FIELD

In a first aspect, the invention relates to a shock-absorbing layer.

In a second aspect, the invention relates to a method for manufacturing a shock-absorbing layer.

### STATE OF THE ART

In general, shock-absorbing layers have an important function in situations involving impact or vibration. Among other things, shock-absorbing layers have an important role in reducing the risk of injury in athletes. When athletes play on a hard surface, the impact of their movements can be harmful to their muscles, joints and bones, and can significantly increase the risk of injury.

In the context of sports, a well-known example is the use of a shock-absorbing layer in an artificial turf installation. The shock-absorbing layer in an artificial turf installation is often is a layer of cushioning material installed under artificial turf to provide additional shock absorption and cushioning. This layer of material is usually made of foam, rubber or other synthetic materials, and is designed to help prevent injuries that may result from falls or bumps on the artificial turf field. On top of this shock-absorbing layer is a stabilizing layer, followed by a layer of artificial turf with a cut pile. Here, tufting of artificial grass is a well-known and widely used technique in the production of artificial turf fields. In this technique, the artificial grass is interwoven with a textile backing. There are several methods of tufting, including the so-called cut-pile process. In this technique, the fibers are cut, resulting in a smooth surface which provides a soft, comfortable surface.

Although artificial turf fixtures with known shock-absorbing layers already offer advantages over natural grass fields, the overall shock absorption and energy restitution properties also still have room for improvement. In addition its known shock-absorbing layers are disadvantageous due to a limited ability to drain fluids, such as water, from the artificial turf installation.

Consequently, there is a need for an improved shock-absorbing layer that can be widely applied in various devices, with improved shock absorption properties.

One of the biggest challenges in this, is finding the optimal relationship between high bending stiffness, and minimal material usage. Typically, more “mass” provides higher bending stiffness, but makes for a more expensive and heavier product, which is not desirable.

The present invention seeks to solve at least some of the above-mentioned problems and drawbacks.

### SUMMARY OF THE INVENTION

In a first aspect, the invention relates to a shock-absorbing layer according to claim 1. Preferred embodiments of the first aspect of the invention are described in claims 2 to 15.

The invention relates to a shock-absorbing layer comprising a backing cloth having a top surface, a bottom surface and a plurality of loops consisting essentially of at least one elastic polymer.

The cross section of the loops comprises a hollow closed structure and/or at least two free ends, wherein the cross section between said two ends comprises an elongated segment, and wherein the elongated segment extends along a longitudinal axis, wherein the longitudinal axis comprises a first tangent vector at a first point and a second tangent vector at a second point, which first and second tangent vectors define a mutual angle between 20° and 160°, preferably between 30° and 150°.

The loops can be attached to the backing cloth according to a loop-pile principle. The shock-absorbing layer can be used as an intermediate layer between a hard surface and a top layer of sports mats, for example, to absorb shock and impact and prevent injury. It is particularly suitable for sports such as gymnastics and judo, where athletes often make hard landings. It can also be integrated into artificial turf installations for added cushioning and protection from injury. In addition, it is ideal for use as an underlayment for playgrounds and other recreational areas where fall protection is essential.

The loop-pile structure offers several, including its fibers are more durable and less prone to wear and tear because the loops are not cut. The loops are also capable of rebounding after being compressed, providing better shock absorption. In addition, the loop structure allows for better drainage and ventilation, which can improve the life of the shock-absorbing layer and prevent water accumulation, which can cause slipperiness.

The elastic polymer fibers provide more elasticity and resilience, leading to better shock absorption and energy return. A resilient polymer such as a thermoplastic polymer is preferred for this purpose. Resilient polymers have the ability to return to their original shape or position after compression

This shock-absorbing layer also has the surprising advantage of being fully recyclable. In particular, because both the backing cloth and the coating of the shock-absorbing layer are essentially made of polyethylene and/or polypropylene.

### DESCRIPTION OF THE FIGURES

FIG. 1 illustrates a schematic representation of a method according to preferred embodiments of the invention for manufacturing a shock-absorbing layer for an artificial turf installation, wherein a shock-absorbing layer is shown as a cross-section.

FIG. 2 illustrates a possible (transverse) section of the loops or fibers, perpendicular to the longitudinal direction.

### DETAILED DESCRIPTION

The invention relates to a shock-absorbing layer, preferably for an artificial turf installation.

Unless otherwise defined, all terms used in the description of the invention, including technical and scientific terms, have the meaning as generally understood by those skilled in the technical field of the invention. For better assessment of the description of the invention, the following terms are explicitly explained.

The term “polymer” refers to a compound consisting of at least two or more monomers. The term “recyclable” refers to materials that can be converted into another material or product for a different or similar use or the extraction of at least one of the individual components or materials of the product for use of that component or material in another product. When the term “fully recyclable” is used, the material or system, in this document, is to be understood as a material or system of which all the various components can be converted into another material or product for another or similar use. To be fully recyclable, at least 90% of the carbon present in the product to be recycled should end up in the recycled product, preferably 95% and more preferably 99%. In recycling, an item is reused, whether for a different purpose or not. In recycling, a waste is transformed into a new product.

The term “radius of curvature” refers to the radius of the circle that best approximates the curvature of a curve at a given point. It is a measure of how strongly the curve is curved at that point. In the context of the invention, the curve refers to the outline of the cross section of the loops.

“A,” “the,” and “the” refer to both singular and plural in this document unless the context clearly assumes otherwise. For example, “a segment” means one or more than one segment.

When “approximately” or “around” is used herein in reference to a measurable quantity, a parameter, a period of time or moment, and the like, it means variations of +/−20% or less, preferably +/−10% or less, more preferably +/−5% or less, even more preferably +/−1% or less, and even more preferably +/−0.1% or less than and of the quoted value, insofar as such variations are applicable in the described invention. Here, however, it should be understood that the value of the quantity in which the term “about” or “around” is used is itself specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Citing numeric intervals by the endpoints includes all integers, fractions and/or real numbers between the endpoints, these endpoints included.

In a first aspect, the invention relates to a shock-absorbing layer comprising a backing cloth having a top surface, a bottom surface, and a plurality of loops.

In particular, the loops are formed from fibers made essentially from at least one elastic polymer. The cross-section of the loops comprises a hollow, closed structure and/or has at least two free ends, wherein the cross-section between said two ends consists of an elongated segment, and wherein the elongated segment extends along a longitudinal axis, wherein the longitudinal axis comprises a first tangent vector at a first point and a second tangent vector at a second point, which first and second tangent vectors define a mutual angle between 20° and 160°, preferably between 30° and 150°.

In this way, the invention provides a solution for optimizing bending stiffness with respect to the material used. In the prior art, bending stiffness has always been improved by making the loops thicker, longer and/or wider, which, however, greatly increases the amount of material used. In the invention, the bending stiffness is inventively increased by optimizing the cross-section of the fiber that extends in two dimensions, thus propping it up against sagging, as it were, without excessively increasing the amount of material used for this purpose.

Because (at least) one segment extends in two mutually different directions, they reinforce each other in terms of bending stiffness. This technique is used in the construction industry, where profiles are typically reinforced with perpendicular sections to each other, such as an I-profile. In the context of fibers, which are typically manufactured via extrusion or other techniques, cross-sectional variations can also be used, as discussed further. These include concave structures, such as an O-shape, or a concave polygon, such as a triangle, quadrangle, square, etc., as well as other shapes, as discussed further.

Primarily targeted for use as a shock-absorbing layer for artificial turf installations to provide additional cushioning and protection from injury. This not only makes artificial turf fields safer, but also more durable and resistant to wear and tear. The shock-absorbing layer is also ideal for use as an underlayment for playgrounds and other recreational areas where fall protection is important.

However, the shock-absorbing layer is a versatile layer that can be applied in a variety of ways. Preferably, it can be used as an intermediate layer between a hard surface and an upper layer of sports mats to absorb shock and impact, thus preventing injury. Thus, the shock-absorbing layer is ideal as a mat or carpet pad for a mat for sports such as gymnastics and judo, where athletes often have to make hard landings. This layer helps absorb the impact of landings, providing a safer and more comfortable training environment.

The shock-absorbing layer can also possibly be used as a mattress, providing good support and better pressure distribution while sleeping. It can help reduce pressure points on the body and improve the sleeping experience

To ensure improved shock absorption compared to existing techniques, the loops are formed with a cross-section according to claim 1. This cross-section increases the bending stiffness of each loop, thereby improving the shock-absorbing effect of the entire layer, without the need for additional measures, such as, for example, providing a coating layer that would increase the bending stiffness. A section that includes a segment that has two longitudinal axes angled 20 to 160 degrees will absorb forces better in the event of a deformation because material is concentrated along the longitudinal axes, which support each other at said angle. This creates a stiffer loop which increases the resilience of the shock-absorbing layer.

According to a preferred embodiment, the elongated segment along the longitudinal axis has a dimension perpendicular to the longitudinal axis which is at least 10%, and preferably at least 25%, and more preferably at least 35%, and more preferably at least 50% of the dimension along the longitudinal direction. At these dimensions, the elongated segment maintains a length along the longitudinal direction that is large enough to effectively absorb forces, as described above, without a too small dimension in the direction perpendicular thereto making the loop in this longitudinal direction vulnerable to plastic deformation and undermining this advantageous effect.

According to a preferred embodiment, the cross section of the loops comprises one or more elongated segments forming an angle between 20° and 160°, preferably between 30° and 150°, and/or wherein the tangent to the one or more elongated segments in the first point is substantially perpendicular to the tangent to the one or more elongated segments in the second point. When the cross section of the loops comprises several corners, the effect described above will be amplified. This further increases the bending stiffness of the loops and consequently the shock-absorbing effect of the overall shock-absorbing layer.

According to a preferred embodiment, the intersection of the loops has or comprises one or more of the following shapes: C, E, F, H, J, K, L, M, N, O, S, T, V, W, X, Y, Z. These shapes comprise multiple longitudinal axes which are at an angle between 20 and 160 degrees, thereby producing the positive effect described above. It goes without saying that further shapes are also provided, and, in particular, shapes that comprise one or more of those mentioned above.

According to a preferred embodiment, the loops do not comprise a coating. Current techniques often use a coating to increase the stiffness of the shock-absorbing layer. However, coatings have an adverse effect on service life by increasing the fragility of the loops. In addition, the application of coatings also has an adverse effect on the environment. Chemicals and energy-intensive processes are often used in the production of coatings, which can lead to greenhouse gas emissions, pollution, and the use of unsustainable raw materials. Further, when using shock-absorbing coatings in an outdoor environment, coatings can degrade over time due to exposure to sunlight, rain, and abrasion, with chemical particles entering the soil or waterways. A shock-absorbing coating according to current claims offers an effective alternative to improving the shock-absorbing performance of a shock-absorbing layer, making a coating unnecessary, even detrimental.

According to a preferred embodiment, the loops in the shock-absorbing layer are specifically oriented depending on the application of the shock-absorbing layer. The bending strength of the loops may depend on the bending orientation. As a result, a specific orientation and desired bending strength can be obtained that is tailored to the application of the shock-absorbing layer. In a further embodiment, the shock-absorbing layer comprises loops in at least two, and preferably three, different orientations, where the shock-absorbing strength is locally tailored to the application by local variation in the number of loops in the first, second and third orientations.

According to a preferred embodiment, the cross-section has at least one point has a radius of curvature of at least 8 mm, preferably at least 4 mm, more preferably at least 3 mm, even more preferably at least 2.5 mm, even more preferably at least 2.0 mm, even more preferably at least 1.5 mm, even more preferably at least 1.0 mm. In a possible embodiment, the radius of curvature at said at least one point is at least 0.01 mm, preferably at least 0.025 mm, more preferably at least 0.05 mm, even more preferably at least 0.10 mm, even more preferably at least 0.25 mm, even more preferably at least 0.50 mm.

Preferably, the cross-section has a section of at least 5% of the length of the cross-section, preferably at least 10%, more preferably at least 20%, even more preferably at least 40%, where the radius of curvature is at most 8 mm, preferably at most 4 mm, more preferably at most 3 mm, more preferably at most 2.0 mm, even more preferably at most 1.5 mm, even more preferably at most 1.0 mm.

Preferably, the cross-section has a radius of curvature of substantially 0 mm at at least one point, indicating the presence of an abrupt angle, rather than a curve (as, e.g., in the case of a T-shape).

According to a preferred embodiment, the segment has a minimum enclosing rectangle (minimum bounding rectangle) with a length that relates to the width with a value of at most 10:1, preferably at most 8:1 and more preferably at most 5:1. Even more preferably, it is at most 4:1 or even 3:1 or 2:1 or 3:2 or lower, such as e.g. 1:1. In a possible embodiment, the minimum enclosing rectangle is approximately square. The minimum enclosing rectangle is the rectangle with the smallest area that completely encloses the cross-section. This gives a view of the extent to which the cross-section extends along two mutually perpendicular axes, which is crucial to obtain sufficient bending stiffness, given that the “rib” or “bulge” by which the cross-section extends in the smallest dimension typically provides the rigidity, and serves as a reinforcement that causes the loop to bend less easily along an axis along the longest dimension.

According to a further preferred embodiment, the minimum enclosing rectangle has a shortest dimension of at least 0.1 mm, preferably at least 0.25 mm, more preferably at least 0.5 mm, even more preferably at least 0.75 mm, and even more preferably at least 1.0 mm. This provides sufficient reinforcement to achieve a desired minimum bending stiffness.

According to an alternative further preferred embodiment, the minimum enclosing rectangle has a longest dimension of at least 0.1 mm, preferably at least 0.25 mm, more preferably at least 0.5 mm, even more preferably at least 0.75 mm, and even more preferably at least 1.0 mm. This provides sufficient reinforcement to achieve a desired minimum bending stiffness.

According to an alternative further preferred embodiment, the minimum enclosing rectangle has a longest and shortest dimension of at least 0.1 mm, preferably at least 0.25 mm, preferably at least 0.5 mm, preferably at least 0.75 mm, and preferably at least 1.0 mm. This provides sufficient reinforcement to achieve a desired minimum bending stiffness.

According to a preferred embodiment, the cross-section comprises a segment having an average thickness of at least 0.1 mm, and preferably at least 0.15 mm, and more preferably at least 0.2 mm, and more preferably at least 0.2 mm, and more preferably at least 0.3 mm, and more preferably at least 0.4 mm, over a length of at least 0.1 mm, and preferably at least 0.2 mm.

According to a preferred embodiment, the individual segments (sections between nodes) of the cross-section have a thickness (dimension of the cross-section perpendicular to the longitudinal direction) between 0.05 mm and 0.5 mm, preferably between 0.1 mm and 0.4 mm, more preferably between 0.15 mm and 0.3 mm, even more preferably between 0.175 mm and 0.25 mm.

According to a further preferred embodiment, the minimum enclosing rectangle has a shortest dimension of at most 4 mm, preferably at most 3 mm, more preferably at most 2 mm, even more preferably at most 1.75 mm, and even more preferably at most 1.50 mm. This provides sufficient reinforcement to achieve a desired minimum bending stiffness without using too much material.

Preferably, the loops are attached to the backing cloth according to a loop-pile principle, the number of loops per unit area being at least 80,000 loops per m² and at most 200,000 loops per m². An important advantage of the shock-absorbent layer manufactured with a loop-pile structure is that it offers a longer service life than, for example, cut-pile tufting, also known as cut-pile. This is because the loops in the loop-pile structure provide a dense surface suitable for absorbing shock. The tufted loops are also capable of springing back up after compression, making them good at absorbing shock, which is less the case with classic cut-pile mats. The loop-pile structure offers more cushioning and resilience because the fiber loops can move and compress, providing better impact absorption. This is especially important in applications where shock absorption is crucial, such as sports fields and playgrounds.

Also, fibers provided as loop-pile are generally more durable than cut-pile because the fiber loops are not cut. This means the fibers are less likely to wear out and therefore last longer. In addition, loop-pile fibers are less prone to linting, so the shock-absorbing layer retains its cushioning properties better.

Furthermore, a loop-pile shock-absorbent layer provides better drainage and ventilation than a cut-pile layer by allowing more space between the fiber loops for water and air to pass through. This can extend the life of the shock-absorbent layer and improve user safety by preventing water from accumulating and causing slipperiness.

According to a preferred embodiment, the fibers comprise an elastic polymer, this provides higher elasticity and resilience, leading to improved shock absorption and energy restitution properties. Preferably a resilient polymer such as, for example, a thermoplastic polymer. By a resilient polymer is meant a material that has particularly resilient properties and consequently can return to its original shape or position after compression. Such polymers may be made of polyvinyl chloride (PVC), polyethylene (PE), polypropylene (PP), polyamide (PA), ethylene-propylene-diene monomer (EPDM) or any other suitable polymer.

According to a further and/or alternative embodiment, the elastic polymer comprises a recycled elastic polymer.

According to an embodiment, the plurality of loops comprise at least 90 weight % of an elastic polymer selected from: PE, PP, PVC, PA, EPDM rubber, Elastan, isoprene rubber, neoprene, isoprene-butyl rubber, polyurethane, natural rubber, siloxanes and hypalon. Preferably, the loops comprise essentially PE or PP.

According to an embodiment, the loops are provided in rows, wherein a distance between the rows of loops is at least 0.05 mm, preferably at least 0.1 mm, preferably at least 0.2 mm, preferably at least 0.3 mm, preferably at least 0.4 mm, at least 0.5 mm, preferably at least 1.0 mm, preferably at least 1.5 mm, preferably at least 2 mm, such as, for example, 2.5 mm.

Preferably the distance between the rows is at most 10 mm, preferably at most 9.0 mm, preferably at most 8.0 mm, preferably at most 7.0 mm, preferably at most 6.0 mm, preferably at most 5.0 mm, preferably at most 4.0 mm, at preferably at most 3.5 mm, preferably at most 3.0 mm, such as for example 2.5 mm.

Preferably, the distance is between the above lower and upper limits. This distance is extremely suitable for obtaining a dense surface suitable for absorbing shocks.

According to an embodiment, the fibers have a linear mass of at least 250 dtex and at most 8000 dtex, preferably between 1500 dtex and 6000 dtex, more preferably between 3000 dtex and 5000 dtex, such as for example about 4000 dtex. The linear mass of the fibers is directly related to their strength. By requiring an optimum minimum linear mass, the invention ensures that the fibers are strong enough to withstand the load they must bear when absorbing shock. On the other hand, the linear mass should not be too high, as this may limit the flexibility of the fibers and reduce their shock-absorbing properties. By preferring fibers with said linear, the optimum balance between strength and flexibility can be achieved. As a result, the shock-absorbing layer will have the required strength to absorb shock, while at the same time maintaining the flexibility of the fibers to ensure maximum shock absorption.

According to an embodiment, for each 10 cm of the backing cloth, the fiber is inserted through the backing cloth at least 30 times and at most 90 times, preferably at least 35 times and at most 75 times, preferably at least 40 times and at most 60 times. Here, the length of 10 cm is taken along the direction of the rows of loops. Having a certain amount of loops per unit area and per length of backing cloth is essential for achieving a good shock-absorbing effect. This creates a sufficient amount of loops to achieve good shock absorption. A higher number of loops per unit area and per length of backing cloth results in better shock absorption and increased surface stability. In addition, the number of loops increases the durability and longevity of the shock-absorbing layer. Thus, it is important to have an appropriate number of loops to achieve good performance.

According to an embodiment, the loops have a pile height of at least 4 mm and at most 12 mm, preferably at least 6 mm and at most 10 mm. The pile height is determined by the distance from the backing cloth to the point on the loop farthest from the backing cloth. The pile height of the loops affects the shock-absorbing properties of the material. A higher pile height does not necessarily mean better shock absorption properties. This optimal pile height is suitable for cushioning shock. This is because at this pile height, the loops have sufficient freedom of movement to absorb and cushion impacts, but also remain close enough to the backing cloth to provide stability. Too high a pile height can lead to reduced stability and too low a pile height can limit shock absorption properties. Pile height should therefore be carefully chosen based on the intended application and the required shock absorption properties.

According to an embodiment, the shock-absorbing layer is coated, applied to the backing cloth, suitable for fixing the loops. Preferably, the coating is applied to the top surface of the backing cloth. The use of a coating on the shock-absorbing layer can offer several advantages. First, the coating can provide better adhesion of the loops to the backing cloth, making the shock pad more durable and less likely to wear out. In addition, the coating can help keep the loops in place and prevent them from shifting or becoming loose. This can result in a more uniform and reliable shock-absorbing layer. Finally, the coating can also help improve the shock-absorbing layer's resistance to moisture and other outside influences.

According to an embodiment, the coating comprises polyethylene, polypropylene or a combination of both. Preferably, the primary coating consists of at least 50 weight % of polyethylene and/or polypropylene, preferably 70 weight %, more preferably 90 weight % and most preferably 99 weight % of polyethylene and/or polypropylene. Polyethylene and polypropylene are both thermoplastic polymers widely used for their properties such as flexibility, durability, lightness and resistance to chemicals. These properties make them suitable for a variety of applications, including shock coating. Polyethylene and polypropylene are also relatively inexpensive compared to other polymers, which makes the use of these materials as shock-absorbent coating cost-effective. In addition, these materials are not harmful to the environment and can be recycled. Opting for a combination of the two materials optionally offers the possibility of combining the properties of both polymers to create an optimal coating with a balanced combination of strength, flexibility and adhesion.

It is also preferable to choose not to use a coating. This is because tufting the fibers creates a solid bond between the fibers and the backing cloth, making the shock-absorbing layer durable and resistant to abrasion and deformation. This can potentially provide material savings because no additional coating is needed.

According to an embodiment, the backing cloth is essentially made of polyethylene, polypropylene or a combination of both. Preferably, the backing cloth consists of at least 50 weight % of polyethylene and/or polypropylene, preferably 70 weight %, more preferably 90 weight % and most preferably 99 weight % of polyethylene and/or polypropylene. In a particularly preferred embodiment, the backing cloth comprises a woven polypropylene layer. The use of polyethylene, polypropylene or a combination of both as the main material for the backing cloth has several advantages. These materials are lightweight, making the backing cloth easy to handle and install. In addition, they are durable and resistant to wear and deformation, making the backing cloth long-lasting and suitable for intensive use. The woven polypropylene layer in the special preferred performance form provides additional strength and stability to the backing cloth, which is essential for tufting the fibers. The backing cloth serves as backing for tufting and therefore must be sturdy enough to hold the fibers in place and prevent them from shifting or coming loose.

Such embodiments have the surprising advantage that the shock-absorbing layer is recyclable, preferably even completely recyclable. In particular, because both the backing cloth and the coating of the shock-absorbing layer are essentially made of polyethylene and/or polypropylene.

According to an embodiment, the backing cloth has a weight of at least 150 gr/m², preferably at least 160 gr/m², preferably at least 170 gr/m², e preferably at least 180 gr/m², preferably at least 190 gr/m², preferably at least 200 gr/m², preferably at least 210 gr/m⁽²⁾, preferably at least 220 gr/m², preferably at least 230 gr/m², preferably at least 240 g/m², and preferably at most 350 g/m², preferably at most 340 g/m², preferably at most 330 g/m², preferably at most 320 g/m², preferably at most 310 g/m², preferably at most 300 g/m², preferably at most 290 g/m², preferably at most 280 g/m², preferably at most 270 g/m², at most 260 g/m². An important advantage of a backing cloth of said weight is that the cloth is sturdy and durable. It can absorb the shocks created by the shock-absorbing layer and can support the weight of the material used. In addition, a heavier backing cloth offers better protection against root growth and abrasion, thus extending the life of the shock-absorbing material. However, a lighter backing cloth can also have advantages, such as lower cost and better water permeability. So the weight of the backing cloth depends on the application and the desired properties.

According to an embodiment, the shock-absorbing layer has a pile weight of at most 5.0 kg/m², preferably at most 4.0 kg/m², preferably at most 3.0 kg/m², preferably at most 2.5 kg/m², at most 2.0 kg/m², preferably at most 1.5 kg/m², at most 1.0 kg/m². Pile weight is the weight of the fibers per square meter. It indicates how closely the fibers are tufted together. A higher pile weight means that more fibers per square meter have been used, which can provide more shock absorption and comfort. However, it is also important to look at the composition and density of the fibers, as these also affect the shock-absorbing properties. Named pile weight has the effect of making the shock-absorbing layer light and easy to handle. This makes it easier to install and move the shock-absorbing layer if necessary.

According to an embodiment, the shock-absorbing layer has a thickness of at least 0.1 mm, preferably at least 0.5 mm, preferably at least 1 mm, preferably at least 2 mm, and at most 100 mm, preferably at most 75 mm, preferably at most 50 mm. This thickness provides a higher degree of protection against impacts and falls, which increases the safety of users. Said layer thickness is also optimal for use in various applications.

According to a preferred embodiment of the first aspect of the invention, the shock-absorbing layer also comprises a plurality of perforations. Such implementation form has the advantage of greatly increasing the ability to drain fluids, such as water.

According to a preferred embodiment, the shock-absorbing layer has a shock absorption, measured according to EN 14808, of at least 15% and preferably at least 30%. Because the shock-absorbing layer a shock absorption of at least 15%, this shock-absorbing layer is very suitable for improving shock absorption and energy restitution properties of the artificial turf installation.

According to a preferred embodiment, the shock-absorbing layer has a tensile strength, measured according to EN 12230, of at least 0.10 MPa and preferably at least 0.15 MPa. Because the shock-absorbing layer has a tensile strength of at least 0.10 MPa, the layer is sufficiently firm to absorb the forces developed by users of the artificial turf installation.

According to a preferred embodiment, the water permeability of the shock-absorbing layer measured according to EN 12616 is at least 180 mm/h.

In a second aspect, the invention relates to a method for manufacturing a shock-absorbing layer, comprising providing a backing cloth, and inserting fibers according to the claims into the backing cloth by tufting on a tufting machine.

In a preferred embodiment, the method comprises tufting the fibers under a pile height between at least 4 mm and at most 12 mm, tufting the fibers in loops according to a loop-pile, wherein the number of loops per unit area is at least 100,000 loops per m² and at most 140,000 loops per m².

According to an embodiment, the loops have a cross section that is circular, preferably with a diameter of 0.2-30 mm, preferably between 0.25 mm and 10 mm, more preferably between 0.5 mm and 2.0 mm, more preferably between 0.75 mm and 1.5 mm. According to an embodiment, the loops have a cross section that is grass-shaped, preferably having a maximum thickness of 0.2-1 mm and length of 0.5-3 mm. According to an embodiment, the loops have a cross section that is doughnut shaped, preferably the cavity inside has a diameter of 0.2-10 mm and the outer diameter of the cross section of the loop is 1 to 3 times the diameter of this cavity. According to an embodiment, the loops have a cross section that is eclipsed, preferably having a maximum thickness of 0.2-1 mm and length of 0.5-3 mm. According to an embodiment, the loops are arranged in parallel straight rows. According to an embodiment, the loops are arranged in parallel zig-zag rows.

This method is advantageous because it ensures the production of a shock-absorbing layer that is both durable and effective at absorbing shock and vibration. By tufting the fibers into loops according to a loop-pile, a springy layer is created that has excellent shock absorption properties. In addition, using a backing cloth as a base for the fibers ensures that the layer remains firm and stable, which is important for maintaining its shock absorption properties over the long term. Method specifications, such as the pile height and number of loops per unit area, are also important because shock absorption is optimized without compromising the durability of the layer.

A further advantage of this method is that it can easily be carried out mechanically. In addition, tufting machines suitable for this purpose are already used for the manufacture of artificial turf, for example, and consequently they can also be used for the manufacture of a shock-absorbing layer according to the present invention without cumbersome modifications.

It should also be noted that a loop-pile shock-absorbing layer is better than a cut-pile shock-absorbing layer for several reasons. First, a loop-pile structure offers more cushioning and resilience because the loops of fibers can move and compress, providing better impact absorption. This is especially important in applications where shock absorption is crucial, such as sports fields or playgrounds. Second, loop-pile fibers are generally more durable than cut-pile fibers because the loops are not cut. This means the fibers are less likely to wear out and therefore last longer. In addition, loop-pile fibers are less prone to linting, so the shock-absorbing layer retains its cushioning properties better. Finally, a loop-pile shock-absorbent layer offers better drainage and ventilation than a cut-pile layer because there is more space between the loops for water and air to pass through. This can extend the life of the shock-absorbent layer and improve user safety by preventing water from accumulating and causing slipperiness.

According to an embodiment, the tufting machine uses a needle density of at least 0.1 cm and at most 0.6 cm, preferably at least 0.15 cm and at most 0.45 cm, more preferably at most 0.45 cm. A higher needle density means that the fibers are more firmly fixed in the backing cloth. As a result, the shock-absorbing layer stays in place better and retains its shape even during intensive use. It also ensures that the fibers are better secured and that the loops become firmer. This not only improves the durability of the layer, but also provides better shock absorption. The fibers are more evenly distributed throughout the backing cloth. This creates a more uniform density of fibers, which contributes to better shock absorption and stability. Furthermore, less material will be wasted because the fibers are better secured and fewer fibers are pulled out of the backing cloth during tufting.

According to a form of implementation, a coating is applied to the backing cloth for fixing the loops. Applying a coating to the backing cloth for fixing the loops has several advantages for manufacturing a shock-absorbing layer. First, the coating helps to better fix the loops of the fibers and protect the fibers from damage. This improves the durability of the shock-absorbing layer and allows it to better withstand heavy use and wear. Another advantage of using a coating is that it provides better adhesion of the fibers to the backing cloth. This results in a more uniform and consistent layer with better stability and shock absorption. In addition, the coating prevents the fibers from shifting or loosening during tufting, resulting in better quality loops. Finally, the coating helps reduce material waste and optimize resource utilization. It reduces the likelihood of fibers coming loose during the production process, resulting in less material waste and more efficient use of available raw materials.

In short, coating the backing cloth is an important step in the manufacture of a shock-absorbing layer. It contributes to the durability and stability of the layer and improves the quality of the loops. In addition, it reduces material waste and optimizes the use of raw materials.

According to an implementation form, per 10 cm of the backing cloth, the fibers are put through the backing cloth at least 30 times and at most 90 times, preferably at least 35 times and at most 75 times, preferably at least 40 times and at most 60 times. Having a certain amount of loops per unit area and per length of the backing cloth is essential for achieving a good shock-absorbing effect. This creates a sufficient amount of loops to achieve good shock absorption. A higher number of loops per unit area and per length of backing cloth results in better shock absorption and increased surface stability. In addition, the number of loops increases the durability and longevity of the shock-absorbing layer. Thus, it is important to have an appropriate number of loops to achieve good performance.

According to a preferred embodiment, the loops are provided in rows, where a distance between the rows of loops is between at least 0.05 mm and at most 3.5 mm.

For example, but not limitingly, the invention relates to the shock-absorbing layer as described herein as a layer for use in an artificial turf installation, wherein the shock-absorbing layer is placed between the substrate and artificial turf installation. Preferably, the shock-absorbing layer is placed under the backing cloth of the artificial turf fixture. As a result, the artificial turf installation will exhibit shock-absorbing properties. This shock-absorbing layer reduces complaints for users of the surface. Alternative shock-absorbing agents, such as a filler made of elastic granules has the disadvantage that it wears out quickly and erodes off the surface. The shock-absorbing layer under artificial turf furnishings has a long lifespan. In addition, they do not affect playing properties such as ball rolling or elasticity of tufts.

A person skilled in the technical field will appreciate that a method according to the second aspect is preferably performed before manufacturing a shock-absorbing layer according to the first aspect. Accordingly, any feature described herein, above as well as below, may relate to either of these two aspects of the present invention.

In what follows, the invention is described using non-limiting figures illustrating the invention, which are not intended or to be interpreted to limit the scope of the invention.

### FIGURES

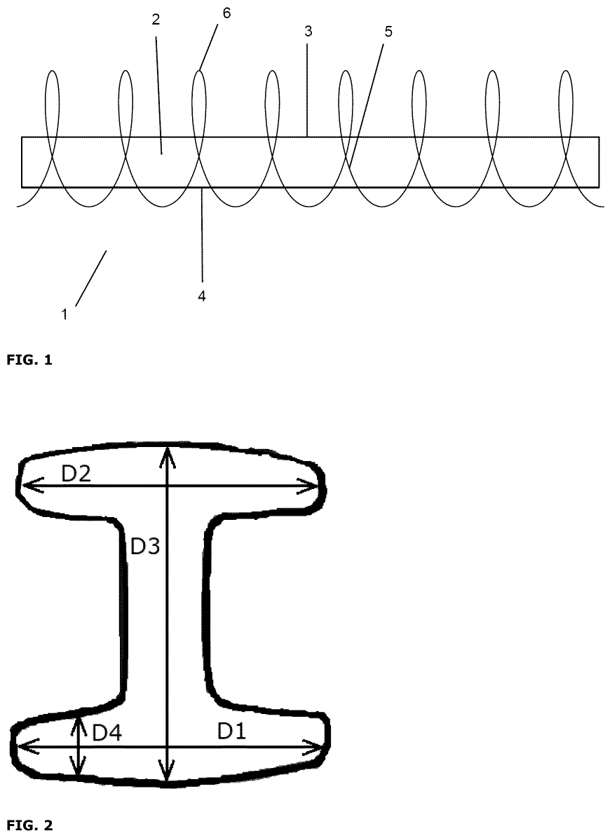

FIG. 1 shows a shock-absorbing layer 1, suitable inter alia as an intermediate layer in an artificial turf installation, according to preferred embodiments of the invention. The shock-absorbing layer 1 includes a backing cloth 2 which is machine tufted. At least one elastic polymer 5 is tufted through the backing cloth 2 according to a loop pile technique. In this process, loops are formed above the top surface 3 of the backing cloth. These loops are formed because the elastic polymer 5 is tufted through the backing cloth 2 via the lower surface 4 of the backing cloth, thereby reappearing the polymer on the upper surface 3 of the backing cloth. A loop 6 is then formed and the elastic polymer is again inserted through the backing cloth 2 via the upper surface 3 until it emerges again from the lower surface 4. This process repeats itself in a given tufting direction, forming a series of loops 6 in the backing cloth 2. The elastic polymer, once it emerges from the upper surface 3, is looped against the tufting direction, as shown in FIG. 1.

The following is a summary of the meaning of the figures used in the figures:
1 shock-absorbing layer
2 backing cloth
3 top surface backing cloth
4 bottom surface backing cloth
5 elastic polymer
6 loops

FIG. 2 shows a possible cross-sectional view of the loops (i.e., of the fibers), in an I-shape. In this embodiment, the cross-section has a height (D3) of 1.108 mm, a width at the top (D2) of 0.995 mm and a width at the bottom (D1) of 1.023 mm, and a thickness (D4) of about 0.202 mm. Obviously, some variation is possible on this, particularly on the thickness of the cross-section, given that the fibers are typically made via an industrial process.

It is assumed that the present invention is not limited to the embodiments described above and that some modifications or changes can be added to the described examples without revaluing the added claims.

1. Shock-absorbing layer, preferably for an artificial turf installation, comprising a backing cloth having an upper surface, a lower surface, and a plurality of loops of fibers comprising of one or more elastic polymers, characterized in that the loops have a cross-sectional shape comprising at least two free ends and wherein the cross-section between said two ends consists of an elongated segment, wherein the elongated segment extends along a longitudinal axis, wherein the longitudinal axis includes a first tangent vector at a first point and a second tangent vector at a second point, which first and second tangent vectors define a mutual angle between 20° and 160°, preferably between 30° and 150°.

2. Shock-absorbing layer according to claim 1, wherein the elongated segment along the longitudinal axis has a dimension perpendicular to the longitudinal axis which is at least 10%, and preferably at least 25%, and more preferably at least 35%, and more preferably at least 50% of the dimension along the longitudinal axis.

3. Shock-absorbing layer according to claim 1 or 2, wherein the one or more elongated segments form an angle between 20° and 160°, preferably between 30° and 150°, and/or wherein the tangent to the one or more elongated segments in the first point is substantially perpendicular to the tangent to the one or more elongated segments in the second point.

4. Shock-absorbing layer according to any of the preceding claims 1 to 3, wherein the cross section has or comprises any of the following forms: C, E, F, H, J, K, L, M, N, S, T, V, W, X, Y, Z.

5. Shock-absorbing layer according to any of the preceding claims 1 to 4, wherein the cross-section is I-or H-shaped, preferably with a height and width having a ratio between them located between 1:2 and 2:1, preferably between 2:3 and 3:2.

6. Shock-absorbing layer according to any of the preceding claims 1 through 5, wherein the loops are not coated.

7. Shock-absorbing layer according to any of the preceding claims 1 to 6, wherein the segment comprises at least one point a radius of curvature not exceeding 4 mm, preferably not exceeding 1.0 mm.

8. Shock-absorbing layer according to the preceding claim 7, wherein the segment cross-section comprises at least one point a radius of curvature of at least 0.05 mm, preferably at least 0.1 mm.

9. Shock-absorbing layer according to any of the preceding claims 1 to 8, characterized in that the loops are provided in rows, where a distance between the rows of loops is between at least 1.5 mm and at most 3.5 mm.

10. Shock-absorbing layer according to any of the preceding claims 1 to 9, characterized in that the fibers have a linear mass of at least 250 dtex and at most 8000 dtex, preferably between 1500 dtex and 6000 dtex, more preferably between 3000 dtex and 5000 dtex.

11. Shock-absorbing layer according to one of the preceding claims 1 to 10, characterized in that per 10 cm of the backing cloth the fibers are put through the backing cloth at least 30 times and at most 90.

12. Shock-absorbing layer according to any of the preceding claims 1 to 11, characterized in that the loops have a pile height of at least 4 mm and at most 12 mm, preferably at least 6 mm and at most 10 mm.

13. Shock-absorbing layer according to any of the preceding claims 1 to 12, wherein the segment has a minimum enclosing rectangle (minimum bounding rectangle) with a length that relates to the width with a value of no more than 10:1, preferably no more than 8:1, and more preferably no more than 5:1.

14. Shock-absorbing layer according to the preceding claim 13, wherein the minimum enclosing rectangle has a shortest dimension of at least 0.1 mm, preferably at least 0.25 mm.

15. Shock-absorbing layer according to any of the preceding claims 1 to 14, characterized in that the shock-absorbing layer has a pile weight not exceeding 2.5 kg/m².

16. Shock-absorbing layer according to any of the preceding claims 1 to 15, characterized in that the shock-absorbing layer has a thickness of at least 0.1 mm and at most 100 mm.

17. Shock-absorbing layer according to any of the preceding claims 1 to 16, characterized in that the loops are attached to the backing cloth according to a loop-pile principle, wherein the number of loops per unit area is at least 40,000, preferably at least 50,000, more preferably at least 60,000, loops per m² and at most 200,000, preferably at most 180,000, more preferably at most 160,000, loops per m².
